(19) United States
(12) Patent Application Publication
(10) Pub. No.: US 2020/0315386 A1
(43) Pub. Date: Oct. 8, 2020

(54) DEVICES, SYSTEMS AND METHODS FOR RECEIVING AND KEEPING PURCHASE/PARCEL

(71) Applicant: Yu Yung Choi, Brooklyn, NY (US)

(72) Inventor: Yu Yung Choi, Brooklyn, NY (US)

(21) Appl. No.: 16/377,162

(22) Filed: Apr. 6, 2019

(51) Int. Cl. A47G 29/20; A47G 29/14; G07C 9/00

(52) U.S. Cl. CPC A47G 29/20; G07C 9/00119; G07C 9/00015; A47G 29/141

(57) ABSTRACT

The present invention provides devices, systems and methods relating to a storage space of a residential consumer after the purchase of an article, and is particularly suitable for ensuring that the storage space to which the carrier delivers the purchase/parcel is a secured space. The secured space includes a receptacle etc. and the cover/door of the receptacle, and a locking mechanism installed on the receptacle and/or the cover/door, which can only be opened by authorized persons/devices. The locking mechanism may include a unique identification and be controlled by a secured device to unlock. The secured device can communicate with access management servers, authorized device or carrier device, etc. The receptacle may be disposed on a folding cart that can be placed outside the house by a lock mode fixing device, an attachment mode fixing device, an embed mode fixing device, a through mode fixing device or an implant mode fixing device. This allows a peace of mind for receiving and keeping the purchase/parcel delivered by a carrier and prevents porch pirates from happening.

### CROSS-REFERENCE TO RELATED APPLICATIONS

The present application is based on, and claim benefit and priority of, U.S. Provisional Patent Application No. 62/653,560 filed on Apr. 6, 2018, the contents of which are incorporated herein in their entirety for all purposes.

### BACKGROUND OF THE INVENTION

### 1. Field of the Invention

The present invention relates to a device, system and method for a storage space for a residential consumer's purchase, in particular for ensuring that a carrier delivers the purchase/package to the storage space as a secured space.

### 2. Description of the Related Art

Firstly, due to the environmental problems caused by the widespread use of plastic, disposable shopping bags are banned in some states. Some shoppers need to have their own family shopping cart (personal cart, family cart, etc.) to transport their purchases to their destinations. A shopping cart can have a basket with a door (or cover) and multiple layers of retractable storage, a device embodied in U.S. Pub. No. 2002/0167139A1 to Prather et al. and U.S. Pub. No. 2005/0156406A1 to Prather, this kind of personal cart is usually used when the family goes out for shopping, and is folded and stored at home when not in use.

Secondly, the increasing popularity of shopping online has led to an increase in parcels delivered by carriers (postmen, etc.). Carriers typically place parcels in public areas (e.g., front doors, front porches, front yards or building hallways). Parcels are conveniently stolen because they are placed in accessible areas. This has solutions for devices and systems such as the U.S. Pub. No. 2003/0006275A1 to Gray which disclosed a receptacle position between a wall or a door for receiving or retaining large packages. The receptacle is expandable with two doors, one inside and one outside using an alignment plane horizontally to support the strength and structural rigidity of the receptacle. U.S. Pub. No. 2003/0154891A1 to Fassbender et al. disclosed a receptacle with a code lock and fastened to a door leaf. The receptacle is mobile and has caster wheels (in FIG. 4 showing four wheels) for that purpose. U.S. Pub. No. 2017/00286905A1 to Richardson et al. disclosed a package box that can have wheels for periodic repositioning, and an electronic lock that can be electronically locked or unlocked.

Thirdly, a system and method for a carrier to access a secured space in a residential area to deliver and/or pick up parcels, and a carrier uses a mobile device to unlock a locking mechanism for the secured space. Such systems and methods are in U.S. Pub. No. 2015/0221152A1 to Andersen and U.S. Pub. No. 2016/0358397A1 to Kristensen et al. They disclosed an identifier and electronic key associated with a lock control unit connected to a locking mechanism associated with a lock control unit. This is a lock control unit that controls a locking mechanism. These devices, systems and methods can be further improved.

### SUMMARY OF THE INVENTION

The devices, systems and methods of the present invention address, resolve and improve all of the disadvantages and laws of the previously known attempted solutions, and provide heretofore unavailable functionality, by advantageously providing for residential consumers to securely keep their purchase (goods, items, etc.) and/or parcel (package, mail, etc.), thereby preventing porch pirates from happening.

There are some problems in above known attempted solutions that need to be improved, such as: The Prather fails to disclose the personal cart may have at least one locking mechanism and may be used for receiving parcel. Gray and Fassbender et al. fail to disclose using at least two wheels to support and level the receptacle. Richardson et al. fail to disclose using at least two wheels to support and level the parcel box and details of how the electronic lock works with the electronic device. Andersen and Kristensen et al. fail to disclose that each locking mechanism may have its own unique identification. Therefore, the inventive device, systems and methods of the present invention provide as follows.

In certain embodiments, a residential of purchase/parcel-keeping device (family shopping cart, family shopping trolley, personal cart/trolley, foldable cart/trolley, family cart/trolley, parcel-keeping device, etc.) is provided for residential consumers according to the different uses of at least one consumer, comprising at least one from the group keeping the purchases and/or parcels. The purchase/parcel-keeping device comprises at least one foldable receptacle (storage, basket, container, secured space, etc.) configured to change from a compact mode to an extended mode to accommodate at least one purchase and/or parcel, otherwise the receptacle folds into compact mode to economize space, wherein at least one side of the receptacle is formed by frame structure material (metal, non-metal, plastic, composite, wooden, bamboo, etc.) joined together, wherein at least two of the materials form a changeable angle, between 0-170 degrees to achieve the compact mode and extended mode function; at least one door or cover (lid, etc.) configured to close at least one side of the receptacle to secure the purchases and/or the parcels in a locked state; at least one locking mechanism configured to lock and/or unlock the door or cover by at least one authorized person (carrier, owner, consumer, customer, etc.). The locking mechanism may be controlled by at least one access management server and/or at least one secured device; the secured device may communicate with at least one authorized device (smartphone, portable device, mobile device, smart home device, robot, unmanned aerial vehicle (UAV), carrier device, consumer device, Internet of Things (IoT) device, etc.); and at least two wheels configured to support at least one side of the receptacle to rolling on the ground and keeping the bottom of the receptacle horizontal while in extended mode.

In certain embodiments, a purchase/parcel-keeping device method enables a residential consumer to receive at least one parcel delivered by a carrier (postman, deliveryman, etc.) in at least one receptacle locked by at least one locking mechanism. The receptacle is able to change from a compact mode to an extended mode to accommodate at least one parcel, otherwise the receptacle folds into compact mode to economize space. The method comprises:

locking or fixing the purchase/parcel-keeping device to a secured object (wall, fence, door, pillar, car, weight, ground, fixture, etc.) by a fixing device and maintained in the compact mode, by a consumer;

setting the receptacle locking mechanism in an unlocked state, by the consumer;

unfolding the receptacle to extended mode, by a carrier;

opening the receptacle door, by the carrier;

placing the parcel into the receptacle, by the carrier;

closing the receptacle door and locking down the receptacle locking mechanism, by the carrier.

In certain embodiments, a secured access system is provided for at least one carrier access to at least one residential consumer's secured space (receptacle, storage, basket, container, room, garage, locked space, etc.) to deliver and/or pick up at least one parcel (package, mail item, etc.). The access system comprises at least one access management server (backend, cloud instance, etc.) storing at least one consumer and at least one carrier's registration data and verifying the registration data that the access management server received from a carrier device; at least one secured device enabling control of at least one locking mechanism of at least one secured space, each of the locking mechanism has a unique identification (UID) assigned, the locking mechanism UID to identify which locking mechanism to be locked/unlocked by a carrier device, a consumer device and/or the access management server over a cloud network, the locking mechanism UID can be displayed as a physical image (QR code label, etc.) for reading by authorized devices, including carrier devices, consumer devices, etc.; at least one consumer device enabling the consumer to register the secured device comprising at least one of the locking mechanism UID to the access management server by a suitable access application (App) being installed on the consumer device; at least one carrier device enabling the carrier to obtain (by lens, NFC, Bluetooth, etc.) the locking mechanism UID to access the secured space and sending the locking mechanism UID to the access management server by a suitable access App being installed on the carrier device; wherein the access management server compares the locking mechanism UID sent by the carrier device with the stored registration data. The comparison is matched—the access management server sends an unlock code to the carrier device, then the carrier device sends the unlock code to the secured device to unlock the locking mechanism and/or the access management server directly sends an unlock code to the secured device to unlock the locking mechanism to access the secured space; wherein the access management server comprises receiving the parcel data from a carrier company, searching the parcel data within the stored registration data to find out the secured device and the carrier device that are matched, sending at least one unlock code to the carrier company and/or the carrier device and storing the unlock code in the carrier device for later use; the carrier device obtains the locking mechanism UID from intending to access the secured space, retrieving the unlock code stored in the carrier device, sending the unlock code to the secured device to unlock the locking mechanism by the access App to access the secured space.

In certain embodiments, a method provides at least one carrier access to at least one residential consumer secured space to deliver and/or pick up at least one parcel. At least one secured space is controlled by a secured device comprising at least one locking mechanism, with each of the locking mechanism having a unique identification (UID) assigned. The secured device enables communication with at least one access management server, at least one consumer device and at least one carrier device. The method comprises:

installing a suitable access application (App) to the consumer device by the consumer, and registering the consumer data (ownership, consumer device, phone number, address, secured device, locking mechanism, etc.) and the locking mechanism UID to the access management server, by the consumer device of the access App;

installing a suitable access App to the carrier device by the carrier, and registering the carrier data (carrier, carrier device, etc.) to the access management server, by the carrier device of the access App;

storing the consumer and the carrier registered data in at least one database, by the access management server;

obtaining the locking mechanism UID by the carrier device where the carrier intends access the secured space, and sending the locking mechanism UID to the at least one access management server, by the carrier device of the access App;

comparing the data received from the carrier device of the locking mechanism UID with the registration data stored, by the access management server;

sending an unlock code where the data matches the locking mechanism UID to the carrier device and/or to the secured device, by the access management server;

unlocking the locking mechanism by the secured device with the unlock code received from the carrier device and/or from the access management server;

opening the secured space door for delivery and/or pickup of the parcel, by the carrier;

closing the secured space door and locking down the locking mechanism, by the carrier.

In certain embodiments, a method provides at least one carrier access to at least one residential consumer secured space to delivery and/or pickup at least one parcel. At least one secured space of door is controlled by a secured device comprising at least one locking mechanism, with each locking mechanism having a unique identification (UID) assigned. The secured device enables communication with at least one access management server, at least one consumer device and at least one carrier device. The method comprises:

installing a suitable access application (App) to the consumer device by the consumer, and registering the consumer data (ownership, consumer device, phone number, address, secured device, locking mechanism, etc.) and the locking mechanism UID to the access management server, by the consumer device of the access App;

installing a suitable access App to the carrier device by the carrier, and registering the carrier data (carrier, carrier device, etc.) to the access management server, by the carrier device of the access App;

storing the consumer and the carrier registered data in at least one database, by the access management server;

receiving the parcel data (name, address, tracking number, phone number, etc.) from at least one carrier company (FedEx, UPS, USPS, Amazon, etc.), by the access management server;

comparing the received parcel data with registration data that is stored to find out a match to the carrier device, the locking mechanism UID and an unlock code, by the access management server;

sending the locking mechanism UID and the unlock code to the carrier device matched, by the access management server;

storing the received locking mechanism UID and the unlock code for later use, by the carrier device;

obtaining the locking mechanism UID intending access to the secured space, by the carrier device of the access App;

retrieving the unlock code stored in the carrier device and sending the unlock code to the secured device to unlock the locking mechanism, by the carrier device of the access App;

opening the secured space door for delivery and/or pickup of the parcel, by the carrier;

closing the secured space door and locking down the locking mechanism, by the carrier.

In certain embodiments, a method provides at least one carrier access to at least one residential consumer secured space to deliver and/or pickup at least one parcel. At least one secured space is controlled by a secured device comprising at least one locking mechanism, with each locking mechanism having a unique identification (UID) assigned. The secured device enables communication with at least one access management server, at least one consumer device to enable processing parcel data. The method comprises:

installing a suitable access application (App) to the consumer device by the consumer, and registering the consumer data (secured device, address, secured space, GPS location, ownership, etc.) and the locking mechanism UID to the access management server, by the consumer device of the access App;

storing the consumer data in at least one database, by the access management server;

receiving the parcel data (name, address, tracking number, phone number, etc.) from at least one carrier company, by the access management server;

sending the parcel data to the corresponding secured device of the matched locking mechanism UID, for the secured device to store, by the access management server; or

storing the parcel data to the database where it matches the consumer data, by the access management server;

taking the parcel or pickup parcel data close to the secured device for recognizing the parcel data, by the carrier;

obtaining the parcel data, by the secured device;

unlocking the locking mechanism by the secured device when obtained the parcel data is matched to store of the parcel data in the secured device or in the access management server of parcel data;

opening the secured space door for delivery and/or pickup of the parcel, by the carrier;

closing the secured space door and locking down the locking mechanism, by the carrier.

### BRIEF DESCRIPTION OF THE DRAWINGS

In the drawings, wherein like reference characters denote corresponding or similar elements throughout the various figures:

FIG. 1 is side view illustrating a purchase/parcel keeping cart in an extended mode and in a compact mode.

FIG. 2 is a partial of side view of FIG. 1 illustrating the purchase/parcel keeping cart of the receptacle cover and locking mechanism.

FIG. 3 is side view illustrating the purchase/parcel keeping cart locked by a lock mode fixing device to a fence.

FIG. 4 is side view illustrating the purchase/parcel keeping cart with two receptacles and two covers.

FIG. 5 is bottom section view illustrating the purchase/parcel keeping cart elevated and leveled by two wheels.

FIG. 6 is side view illustrating the purchase/parcel keeping cart with inside shield.

FIG. 7 is side view illustrating the purchase/parcel keeping cart with outside shield.

FIG. 8 is side view illustrating another foldable purchase/parcel-keeping device standing alone and with closed doors.

FIG. 9 is side view illustrating the purchase/parcel-keeping device showing different door opening and using an implant mode fixing device.

FIG. 10 is side view illustrating the purchase/parcel keeping devices in compact mode and extended mode fixed by an attachment mode fixing device to a wall.

FIG. 11 is side view illustrating the purchase/parcel keeping devices fixed to a wall with various devices.

FIG. 12 is side view illustrating the purchase/parcel keeping devices in compact mode and extended mode embedded by an embed mode fixing device to a wall.

FIG. 13 is front side view illustrating the purchase/parcel-keeping device in compact mode fixed to a door.

FIG. 14 is back side view illustrating the purchase/parcel-keeping device in extended mode fixed by through mode fixing device to the door of FIG. 13.

FIG. 15 is a flow diagram illustrating an embodiment of method for the purchase/parcel-keeping device setting for receiving the parcel delivery.

FIG. 16 is an interaction diagram illustrating the relationship between the access management system and various devices or components in the communication network.

FIG. 17 is a flow diagram illustrating an embodiment of method for the carrier to access the secured space to deliver and/or pick up the parcel.

FIG. 18 is a flow diagram illustrating another embodiment of method for the carrier to access the secured space to deliver and/or pick up the parcel.

FIG. 19 is a flow diagram illustrating other embodiment of method for the carrier to access the secured space to deliver and/or pick up the parcel.

### DETAILED OF THE INVENTION

The devices, systems and methods for keeping purchase and/or parcel in a secured space and access to the secured space of the present invention remedy the disadvantages of all previously known techniques, device, systems and methodologies relating to securely keeping purchase and/or parcel, and access to secured space.

The following clearly and completely describes the technical solutions in the embodiments of the present invention with reference to the accompanying drawings in the embodiments of the present invention. Apparently, the described embodiments are some rather than all of the embodiments of the present invention. All other embodiments obtained by a person of ordinary skill in the art based on the embodiments of the present invention without creative efforts shall fall within the protection scope of the present invention.

In essence, in various embodiments thereof, the inventive devices, systems and methods for keeping purchase and/or parcel in a secured space and access to the secured space comprise of a purchase/parcel-keeping device (family shopping cart, family shopping trolley, personal cart/trolley, foldable cart/trolley, family cart/trolley, parcel-keeping device, etc.) provided for residential consumers according to the different uses of a consumer, comprising at least one from the group keeping the purchases and/or parcels. The purchase/parcel-keeping device comprises at least one foldable receptacle (storage, basket, container, etc.) configured to change from a compact mode to an extended mode to accommodate at least one purchase and/or parcel, otherwise the receptacle folds into compact mode to economize space, wherein at least one side of the receptacle is formed by frame structure material (metal, non-metal, plastic, composite, wooden, bamboo, etc.) joined together, wherein at least two of the materials form a changeable angle, between 0-170 degrees to achieve the compact mode and extended mode function; at least one door or cover configured to close at least one side of the receptacle to secure the purchases and/or the parcels in a locked state; at least one locking mechanism configured to lock and/or unlock the door or cover by at least one authorized person (carrier, owner, consumer, customer, etc.). The locking mechanism may be controlled by at least one access management server and/or at least one secured device; the secured device may communicate with at least one authorized device (smartphone, portable device, mobile device, smart home device, robot, unmanned aerial vehicle (UAV), consumer device, carrier device, Internet of Things (IoT) device, etc.); and at least two wheels configured to support at least one side of the receptacle to roll on the ground and keep the bottom of the receptacle level in the extended mode.

The purchase/parcel-keeping device (cart) may be used as a shopping cart for the consumer keeping the purchases when they go shopping. After shopping, the shopping cart is usually not being used and taking up space at home. Therefore, the purchase/parcel-keeping device (cart) can be placed outdoors for receiving the parcel delivery, thereby preventing porch pirates from happening, which is one of the present invention's “one thing for two uses”. For protecting the purchases and/or the parcels, the purchase/parcel-keeping device provides at least one locking mechanism. The locking mechanism may include (modified, combined, etc.) at least one of mechanical lock, padlock, combination lock, chain lock, cable lock, electronic lock, smart lock, fingerprint lock, etc. The purchase/parcel-keeping device may include at least one secured device to electronically control the locking mechanism. The secured device may be combined or separated with the locking mechanism. The secured device may be a smart device including at least one of communication module, processing module, control module, camera (lens, etc.), speaker, microphone, alarm, fingerprint, GPS, sensors (RFID, NFC, weight, temperature, humidity, light, infrared, pressure, gyroscope, motion, etc.), battery, solar cell, artificial intelligence (Al), smart home etc. The communication may utilize or comply with at least one of cellular communication standards, LTE, UMTS, WiMAX, EV-DO, CDMA, GSM, Bluetooth, Bluetooth Low Energy, Bluetooth Smart, Wireless Fidelity (WiFi), Zigbee, ANT, ANT+, Thread, Internet Protocol (IP), Ethernet, Fast Ethernet, Gigabit Ethernet, ATM, FDDI, Near Field Communication (NFC), Internet of Things (IoT) network, proprietary formats or protocols, and/or combinations. The camera may enable management of at least one of picture, video, barcode, QR code, items recognition, biological recognition, dimensions recognition, motion recognition, depth perception, etc. The secured device enables communication with at least one of access management server, smart home system, shop (virtual shop, physical shop, etc.), shop system, consumer device, carrier device, smartphone, portable device, mobile device, smart home device, robot, unmanned aerial vehicle (UAV), authorized device, IoT device, etc. The purchase/parcel-keeping device is not only used for shopping. It may be used for storage items, etc. For example, the purchase/parcel-keeping device may be used on the beach to store items such as clothing and other articles. It may be used for carrying baby and/or kid for transportation or for fun.

The purchase/parcel-keeping device can be set with various fixings, including at least five mode fixing devices: the first is the locking device, which locks a part of it to a fixed object (fence, fence, post, etc.) by a lock mode fixing device. The second is the attachment setting, which is attached to the fixed object (fence, fence, wall, door, etc.) by the attachment mode fixing device. The third is an embedding setting, in which a part of it is embedded into a fixed object (fence, fence, wall, door, etc.) by an embed mode fixing device. The fourth is the through setting, pass part of it through a fixture (fences, fences, walls, doors, etc.) then fixed by a through mode fixing device. The fifth is an implantation setting, in which part of it implanted to the ground by an implant mode fixing device. The rest of it can be extended by at least two wheels to support the receptacle and keep it level with the ground. By the setting, it may extend inward or outward, or both, and is supported by at least two wheels to keep the receptacle level with the ground. The fixing device includes a position used to install the fixing device, or a position intended to install the fixing device, various mounting parts, assemblies, tools, etc., to complete the setting of the purchasing/parcel keeping device.

The purchase/parcel-keeping device and/or secured device enables communication with, and/or including at least one of: access management server, consumer device, carrier device, smart home system, shop (virtual shop, physical shop, etc.) system, portable device, smartphone, mobile device, smart home device, robot, unmanned aerial vehicle (UAV), authorized device, internet of things (IoT) device, communication module, processing module, control module, camera (lens, etc.), speaker, microphone, alarm, fingerprint, GPS, sensors (RFID, NFC, weight, temperature, humidity, light, infrared, pressure, gyroscope, motion, etc.), battery, solar cell, etc. The communication may utilize or comply with at least one of cellular communication standards, LTE, UMTS, WiMAX, EV-DO, CDMA, GSM, Bluetooth, Bluetooth Low Energy, Bluetooth Smart, Wireless Fidelity (WiFi), Zigbee, ANT, ANT+, Thread, Internet Protocol (IP), Ethernet, Fast Ethernet, Gigabit Ethernet, ATM, FDDI, Near Field Communication (NFC), IoT network, proprietary formats or protocols, and/or combinations. The camera may enable management of at least one of picture, video, barcode, QR code, items recognition, biological recognition, dimensions recognition, motion recognition, depth perception, surveillance, etc. The secured device may constitute many components such as communication module, control module, processor module, power module, locking mechanism, sensors, etc. The components may combine into one unit of device or separate components located in the body of the purchase/parcel-keeping device and/or parcel-keeping device. The secured device, consumer device, carrier device may obtain the parcel data by image, optical, radio, electromagnetic, etc. The purchase/parcel-keeping device and/or secured device may have smart and artificial intelligence (AI) ability enabling interaction with robot, unmanned vehicle, UAV, etc. for the parcel delivery and/or pickup to be automated.

Advantageously, in accordance with various embodiments of the inventive devices, systems and methods enable a residential consumer to receive at least one parcel delivered by a carrier (postman, deliveryman, etc.) in at least one receptacle locked by at least one locking mechanism. The receptacle is able to change from a compact mode to an extended mode to accommodate at least one parcel, otherwise the receptacle folds into compact mode to economize space. The method comprises:

locking or fixing the purchase/parcel-keeping device to a secured object (wall, fence, door, pillar, car, weight, ground, fixture, etc.) by a fixing device and maintained in the compact mode, by a consumer;

setting the receptacle locking mechanism in an unlocked state, by the consumer;

unfolding the receptacle to extended mode, by a carrier;

opening the receptacle door, by the carrier;

placing the parcel into the receptacle, by the carrier;

closing the receptacle door and locking down the receptacle locking mechanism, by the carrier.

Advantageously, in accordance with various embodiments of the inventive devices, systems and methods for keeping parcel in a secured space (receptacle, storage, basket, container, room, garage, home, etc.) and access to the secured space comprising of a secure access system provide for at least one carrier access to at least one residential consumer's secured space to deliver and/or pick up at least one parcel (package, mail item, etc.) The access system comprises at least one access management server (backend, cloud instance, etc.) storing at least one consumer and at least one carrier's registration data and verifying the registration data where the access management server received from a carrier device; at least one secured device enabling control of at least one locking mechanism of at least one secured space, each of the locking mechanism has a unique identification (UID) assigned, the locking mechanism UID to identify which locking mechanism to be locked/unlocked by a carrier device, a consumer device and/or the access management server over a cloud network (communication network, cloud computing, IoT network, etc.); at least one consumer device enabling the consumer to register the secured device comprising at least one the locking mechanism UID register to the access management server by a suitable access application (App) being installed on the consumer device; at least one carrier device enabling the carrier to obtain the locking mechanism UID to access the secured space and sending the locking mechanism UID to the access management server by a suitable access App being installed on the carrier device; wherein the access management server compares the locking mechanism UID sent by the carrier device with the stored registration data. The comparison is matched—the access management server sends an unlock code to the carrier device, then the carrier device sends the unlock code to the secured device to unlock the locking mechanism and/or the access management server sends an unlock code to the secured device to unlock the locking mechanism to access the secured space; wherein the access management server comprises receiving the parcel data from a carrier company, searching the parcel data within the stored registration data to find out the secured device and the carrier device that are matched, sending at least one unlock code to the carrier company and/or the carrier device and storing the unlock code in the carrier device for later use; the carrier device obtains the locking mechanism UID intending to access the secured space, retrieving the unlock code stored in the carrier device, sending the unlock code to the secured device to unlock the locking mechanism by the access App to access the secured space. The secured device may have its own UID. The secured device UID may associate with at least one locking mechanism or locking mechanism UID.

Advantageously, in accordance with various embodiments of the inventive devices, systems and methods for keeping parcel in a secured space and access to the secured space comprises a method provides at least one carrier access to at least one residential consumer secured space to deliver and/or pick up at least one parcel. At least one secured space is controlled by a secured device comprising at least one locking mechanism, with each of the locking mechanism having a unique identification (UID) assigned. The secured device enables communication with at least one access management server, at least one consumer device and at least one carrier device. The method comprises:

installing a suitable access application (App) to the consumer device by the consumer, and registering the consumer data (ownership, consumer device, phone number, address, secured device, locking mechanism, etc.) and the locking mechanism UID to the access management server, by the consumer device of the access App;

installing a suitable access App to the carrier device by the carrier, and registering the carrier data (carrier, carrier device, etc.) to the access management server, by the carrier device of the access App;

storing the consumer and the carrier registered data in at least one database, by the access management server;

obtaining the locking mechanism UID by the carrier device where the carrier intends access the secured space, and sending the locking mechanism UID to the at least one access management server, by the carrier device of the access App;

comparing the data received from the carrier device of the locking mechanism UID with the registration data stored, by the access management server;

sending an unlock code where the code matches the locking mechanism UID to the carrier device and/or to the secured device, by the access management server;

unlocking the locking mechanism by the secured device with the unlock code received from the carrier device and/or from the access management server;

opening the secured space door for delivery and/or pickup of the parcel, by the carrier;

closing the secured space door and locking down the locking mechanism, by the carrier.

Advantageously, in accordance with various embodiments of the inventive device, system and method for keeping parcel in a secured space and access to the secured space comprises a method provides at least one carrier access to at least one residential consumer secured space to delivery and/or pickup at least one parcel. At least one secured space is controlled by a secured device comprising at least one locking mechanism, with each locking mechanism having a unique identification (UID) assigned. The secured device enables communication with at least one access management server, at least one consumer device and at least one carrier device. The method comprises:

installing a suitable access application (App) to the consumer device by the consumer, and registering the consumer data (ownership, consumer device, phone number, address, secured device, locking mechanism, etc.) and the locking mechanism UID to the access management server, by the consumer device of the access App;

installing a suitable access App to the carrier device by the carrier, and registering the carrier data (carrier, carrier device, etc.) to the access management server, by the carrier device of the access App;

storing the consumer and the carrier registered data in at least one database, by the access management server;

receiving the parcel data (name, address, tracking number, phone number, etc.) from at least one carrier company (FedEx, UPS, USPS, Amazon, etc.), by the access management server;

comparing the received parcel data with registration data that is stored to find out a match to the carrier device, the locking mechanism UID and an unlock code, by the access management server;

sending the locking mechanism UID and the unlock code to the carrier device matched, by the access management server;

storing the received locking mechanism UID and the unlock code for later use, by the carrier device;

obtaining the locking mechanism UID intending access to the secured space, by the carrier device of the access App;

retrieving the unlock code stored in the carrier device and sending the unlock code to the secured device to unlock the locking mechanism, by the carrier device of the access App;

opening the secured space door for delivery and/or pickup of the parcel, by the carrier;

closing the secured space door and locking down the locking mechanism, by the carrier.

Advantageously, in accordance with various embodiments of the inventive device, system and method for keeping parcel in a secured space and access to the secured space comprises a method provides at least one carrier access to at least one residential consumer secured space to delivery and/or pickup at least one parcel. At least one secured space is controlled by a secured device comprising at least one locking mechanism, with each locking mechanism having a unique identification (UID) assigned. The secured device enables communication with at least one access management server, at least one consumer device to enable processing parcel data. The method comprises:

installing a suitable access application (App) to the consumer device by the consumer, and registering the consumer data (secured device, address, secured space, GPS location, ownership, etc.) and the locking mechanism UID to the access management server, by the consumer device of the access App;

storing the consumer data in at least one database, by the access management server;

receiving the parcel data (name, address, tracking number, phone number, etc.) from at least one carrier company, by the access management server;

sending the parcel data to the corresponding secured device of the matched locking mechanism UID, for the secured device to store, by the access management server; or

storing the parcel data to the database where it matches the consumer data, by the access management server;

taking the parcel or pickup parcel data close to the secured device for recognizing the parcel data, by the carrier;

obtaining the parcel data, by the secured device;

unlocking the locking mechanism by the secured device when matched the obtain and the stored of the parcel data in the secured device or in the access management server;

opening the secured space door for delivery and/or pickup of the parcel, by the carrier;

closing the secured space door and locking down the locking mechanism, by the carrier.

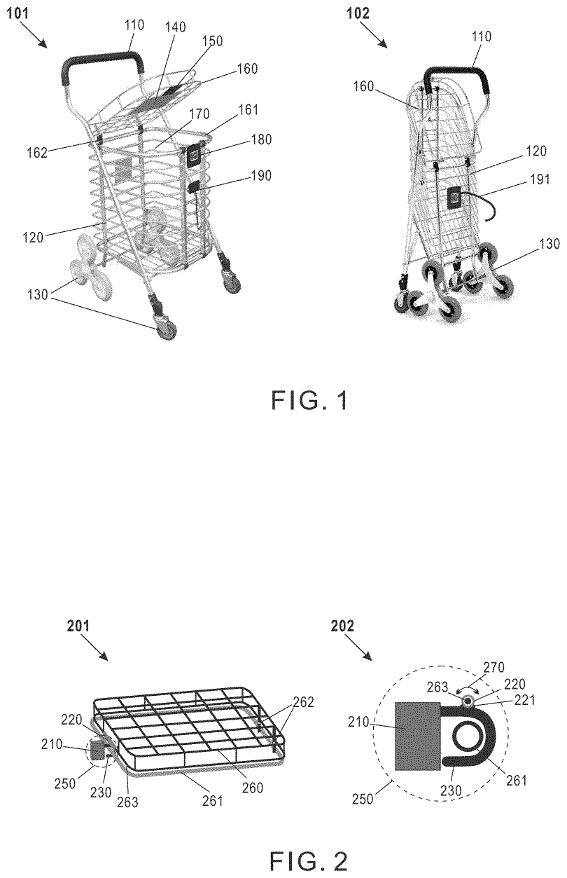

Referring now to FIG. 1 illustrating a purchase/parcel keeping cart in an extended mode 101 and in a compacted mode 102, it is used for the residential consumers for keeping their purchase and/or parcel. Especially for saving and protecting parcels sent by carrier or postman, thereby preventing porch pirates from happening. The purchase/parcel keeping cart 101 has a receptacle 170 to accommodate and/or keeping the purchases and/or parcels in the extended mode 101, otherwise may fold into the compacted mode 102. On the frame 161 of the receptacle 170 opening has at least one hinge 162 which connects with a cover (lid, door, etc.) 160. On the cover 160 there is a locking mechanism 150 to lock to the edge frame 161 to secure the purchases and/or parcels. The locking mechanism 150 only allows authorized person to unlock it. Therefore, the receptacle 170 becomes a secured space. The locking mechanism 150 may be controlled by a secured device 180. The secured device 180 may communicate with access management server, authorized device (smartphone, portable device, mobile device, robot, unmanned aerial vehicle (UAV), consumer device, carrier device, smart home device, Internet of Things (IoT) device, etc.). The locking mechanism 150 may locate on the cover 160, side of the receptacle 170 or the frame 161. The locking mechanism 150 may integrate with the secured device 180. On the outside of the secured device 180 may have a QR code label as unique identification (UID) of the locking mechanism 150. The QR code is a physical image. The locking mechanism 150 is at least one of mechanical lock, padlock, combination lock, chain lock, cable lock, electronic lock, etc. The consumer may set the locking mechanism 150 in an unlock state for receiving the carrier delivery the parcel. The carrier may lock down the locking mechanism 150 after placing the parcel. The secured device 180 may be combined with or separated from the locking mechanism 150. The purchase/parcel keeping cart 101 (102) may have a fixing device of rope shaped lock 190 and/or 191 for locking the purchase/parcel keeping cart 101 (102) to a fixture for security needs. The rope shaped lock 190 (191) may have at least 2 inches of rope (cable, chain, cord, etc.) for surrounding the fixture. The integral frame 161 of the purchase/parcel keeping cart 101 can be used for mounting the fixing device to install the lock mode fixing device, such as the cable lock 190 and the cable lock 191, on different fixing device position.

The receptacle 170 may be formed by frame structure material and joined to each other, wherein at least two of the materials form a changeable angle 120, to change between compact mode and extended mode, the angle 120 may change from 0-90 degrees. The purchase/parcel keeping cart 101 may have solar cell 140 for providing electricity to the secured device 180, etc. The purchase/parcel keeping cart 101 (102) has wheels 130. Shown here is a combined three-wheel design which enables the purchase/parcel keeping cart 101 (102) to climb stairs. Therefore, the purchase/parcel keeping cart 101 (102) has a total of 8 wheels. The wheels 130 may be able to be adjusted to level the receptacle 170. The purchase/parcel keeping cart 101 (102) has handle 110 for the consumer to push-and-pull the purchase/parcel keeping cart 101 (102) to enable movement on the ground. The purchase/parcel keeping cart 101 (102) is a multifunction device for consumer use including secured purchases of shopping and/or secured receiving of parcels.

FIG. 2 is a partial of side view of FIG. 1 illustrating the receptacle cover and locking mechanism of structure 201 and partially 250 enlarged schematic 202. The receptacle frame 261 which is the receptacle edge frame 161 shown in FIG. 1 and connected with the cover 260 by the hinge 262. The cover 260 may be permanently on or detachable from the hinge 262. The other side of cover 260 is connected with the locking mechanism. The locking mechanism comprises lock body 210 and lock shackle 230. On the lock shackle 230 there is a sleeve 220 which is welded together by 221. The sleeve 220 is sleeved on a portion of the cover frame 263 so that the lock shackle 230 can be rotated 270 to hold the receptacle frame 261 and locked. The lock shackle 230 is at least 0.3 inch long. The sleeve 220 may be welded on the lock body 210 instead of the lock shackle 230. The lock body 210 may use physical key, digital key, combination key, etc. to open. The lock body 210 may embed the secured device 180. The locking mechanism may be fixed on the cover 260 or the receptacle frame 261 and does not require rotation. The lock body 210 and lock shackle 230 may be integrally disposed on the receptacle frame 261 or disposed on the cover frame 263; or may be separately provided, respectively disposed on the receptacle frame 261 and disposed on the cover frame 263, as the lock body 210 is disposed on the receptacle frame 261, and lock shackle 230 is disposed on the cover frame 263. The lock shackle 230 may be latch, bolt, hook, wire, cable, chain, rope, etc.

The locking mechanism formed by the lock body 210 and the lock shackle 230 in this embodiment is a type of padlock which has been modified by one of the invention. Since the padlock is inexpensive, it can be used after being modified by the invention. The cost of the purchase/parcel keeping cart is reduced. Of course, the locking mechanism can also be modified by other locks, such as spring lock, bolt lock, cable lock, chain lock, hook lock, electronic lock, fingerprint lock, combination lock, latch lock, etc., or a lock specially made for the purchase/parcel keeping cart. Thus, these locks include at least one of latch, bolt, hook, wire, cable, chain, rope etc. which is at least 0.3 inches long to lock the cover or door.

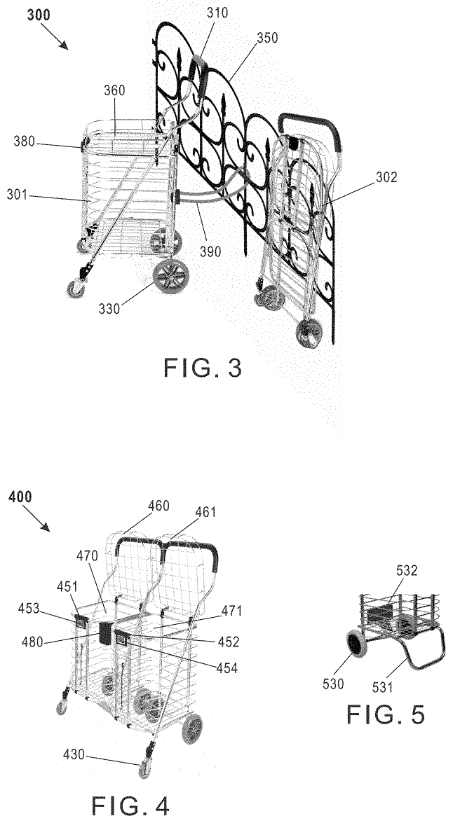

FIG. 3 illustrates the purchase/parcel keeping cart is locked to the fence 300 using the lock mode fixing device 390 (in this case it is a cable lock 390), the cable lock 390 can be integrated with the purchase/parcel keeping cart 301, or it can be removable and installed only when set. When the purchase/parcel keeping cart 301 is in the extended mode, the cover 360 is locked by the locking mechanism 380. The locking mechanism 380 may have a unique identification (UID). The purchase/parcel keeping cart 301 has handle 310 and wheels 330 (shows total of 4 wheels). The purchase/parcel keeping cart 301 may have second locking mechanism which has at least 2 inch of cable, wire, chain, rope, etc. The consumer may lock the purchase/parcel keeping cart 301 to the fence 350 (fixture, etc.) by the cable lock 390 for security and prevent it from being stolen. The cable lock 390 is fixed to the purchase/parcel keeping cart 301. When purchase/parcel keeping cart 301 is not in use, it may stay in the compact mode like purchase/parcel keeping cart 302. The carrier arrives for parcel delivery then unfolds the compact mode of purchase/parcel keeping cart 302 into extended mode of purchase/parcel keeping cart 301. The carrier unlocks the locking mechanism 380 and opens the cover 360, placing the parcel into the receptacle and locking down the locking mechanism 380. If the locking mechanism 380 is mechanical lock which may be set in unlock state by consumer, the carrier only needs to open the cover 360 and place the parcel inside before locking down the locking mechanism 380. If the locking mechanism is an electronic lock, the carrier may obtain (by QR code, RFID, NFC, Bluetooth, etc.) the locking mechanism 380 UID to unlock using the carrier device and/or by the access management server over a communication network (cloud network, etc.), then opening the cover 360 and placing the parcel inside before locking down the locking mechanism 380. The purchase/parcel keeping cart 301 has two locks 380 and 390. The lock 380 or 390 may be any one of locking mechanism, padlock, combination lock, cable lock, chain lock, fingerprint lock, electronic lock, smart lock, etc.; it can also be modified or combined from more than one of them. The lock may be combined with the secured device. The secured device and lock may be a permanent or temporary fixture on the purchase/parcel keeping cart 301.

FIG. 4-FIG. 5 illustrate the purchase/parcel keeping cart 400 in different needs. The purchase/parcel keeping cart 400 has two receptacles 470 and 471, two covers 460 and 461, and two locking mechanisms 451 and 452. The receptacle, the cover and the locking mechanism may be more than two. The locking mechanisms 451 and 452 each have their own unique identification (UID) and are controlled by secured device 480. The locking mechanism UID may be stored in the secured device 480, and the UID may be able to be obtained (scan, read, induction, RFID, NFC, Bluetooth, etc.) by authorized device (smartphone, portable device, mobile device, robot, unmanned aerial vehicle (UAV), consumer device, carrier device, smart home device, Internet of Things (IoT) device, etc.). In here the UID is shown by QR code 453 and 454 (physical image, etc.) The QR code's 453 and 454 data may be stored in the secured device 480 and/or associated to the secured device 480 and/or other UlDs (secure device UID, etc.) stored in the secured device 480. The purchase/parcel-keeping device 400 has a total of 6 wheels 430 for support and leveling of the two receptacles. But for support and leveling, the receptacle may use two wheels 530 and supporting foot 531 shown in FIG. 5. The wheels 530 may be electric wheels powered by a driver device 532. The driver device 532 may include battery, motor, drive system, control system, etc. and may be remote controlled by the consumer device.

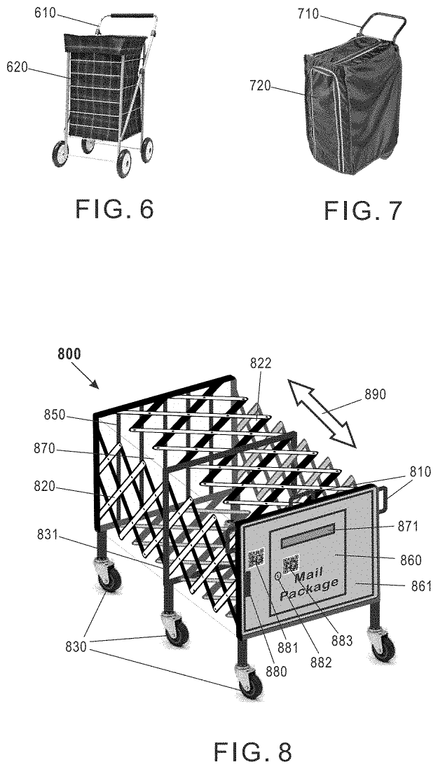

FIG. 6-FIG. 7 illustrate that a purchase/parcel keeping cart may have different shield devices. The shield device 620 may be inside of the receptacle of the purchase/parcel keeping cart 610 in FIG. 6 or the shield device 720 may be outside of the receptacle of the purchase/parcel keeping cart 710 in FIG. 7. The shield device 620 or 720 may be formed by any suitable material (plastic cloth, waterproof fabric, insulation cloth, glass fabric, high-strength fabric, etc.) The material may be single or multilevel. The shield device 620, 720 may have thermal insulation and/or constant temperature monitoring by a temperature sensor in the receptacle. The temperature may be controlled by the secured device, smart home system, consumer device, etc. The shield device 620, 720 may have ventilation system, constant temperature system, etc.

FIG. 8 illustrates a purchase/parcel-keeping device 800, which has a different appearance from FIG. 1. It is other kind of folding cart. The purchase/parcel-keeping device 800 has two receptacles; one is receptacle 870 for accommodating and/or keeping the parcel. Another receptacle (shown in FIG. 10 of 1063) is inside a door 860 for receiving small mail items (letter, etc.) from a window 871. The door 860 is locked by a locking mechanism 882 enabling the consumer to open the door 860 using a physical key and/or mobile key (electronic key, unlock code, etc.). The mobile key may be provided by the consumer device. The locking mechanism 882 has a unique identification (UID) of QR code 883 for authorized device to access. The door 860 forms a mailbox on the other door 861. The door 861 is security for receptacle 870 which includes locking mechanism 880 and QR code 881 (physical image, etc.). Therefore, the receptacle 870 becomes a secured space. The locking mechanism 882 and/or 880 may be controlled by a secured device (shows in FIG. 10 of 1082 and/or 1080). The secured device may be combined or separated with the locking mechanism 882 and/or 880. The secured device may communicate with access management server, authorized device, etc. The purchase/parcel-keeping device 800 is an accordion (fold, extend, etc.) enabling extension 890 from compact mode to extended mode for keeping the parcel. The receptacle 870 is formed by frame structure material joined and crossed together to build a barrier 820, wherein at least two of the materials form a changeable angle 822, to change between compact mode and extended mode. The changeable angle 822 may change between 0-170 degree of any suitable design of the barrier 820 to achieve the extendable result. The door 861 is located on one side of the purchase/parcel-keeping device 800 and another side is closed side 850 or may form another door. The closed side barrier 850 can be used for setting a fixing device position, which can be fixed by a lock mode fixing device (the fixing device 390 in FIG. 3) to a fixture. The purchase/parcel-keeping device 800 has wheels 830 to support and level the receptacle 870. In the middle of the parcel-keeping device 800 may have supporting frames and wheels 831 to also level the receptacle 870. The purchase/parcel-keeping device 800 enables expanding 890 horizontally from compact mode to extended mode with the wheels 830 rolling on the ground. The parcel-keeping device 800 has handles 810 to enable push-and-pull to the purchase/parcel-keeping device 800 to move smoothly on the ground.

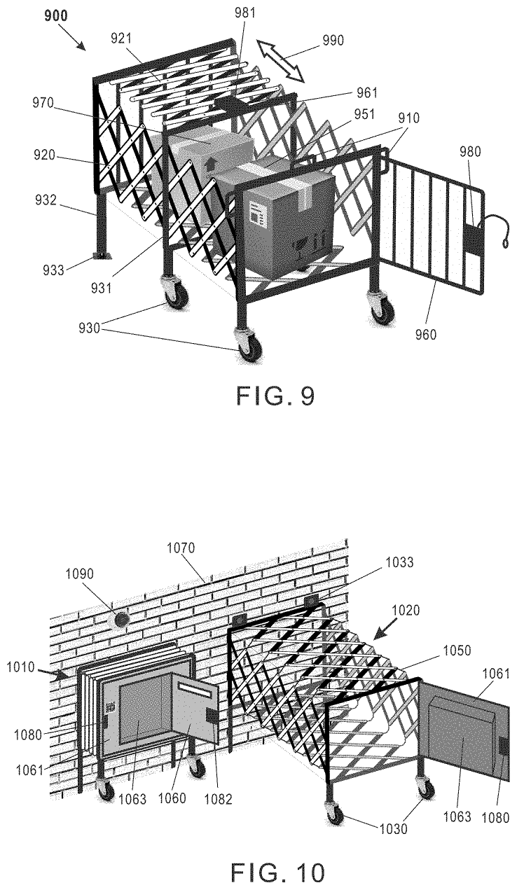

FIG. 9 illustrates the purchase/parcel-keeping device 900 as another design showing a gate door 960 with a secured device 980 included as a cable locking mechanism and a sliding door 961 with a secured device and/or locking mechanism 981. The sliding door 961 is connected with top barrier 921 enabling slide folding 990 to open or close the receptacle 970. The other sides of barrier 920 form the receptacle 970. The sliding door 961 is supported and slides by a support frame 931 with wheels 930. The receptacle 970 is for accommodating and/or keeping the parcel 951. The parcel-keeping device 900 also has handles 910. The door can also be modified for accordion door, folding door, rolling door, etc. The receptacle 970 has two doors 960 and 961, so one receptacle may have more than two doors. The purchase/parcel-keeping device 900 has one part of the foot 932 implanted on the ground by an implant mode fixing device 933.

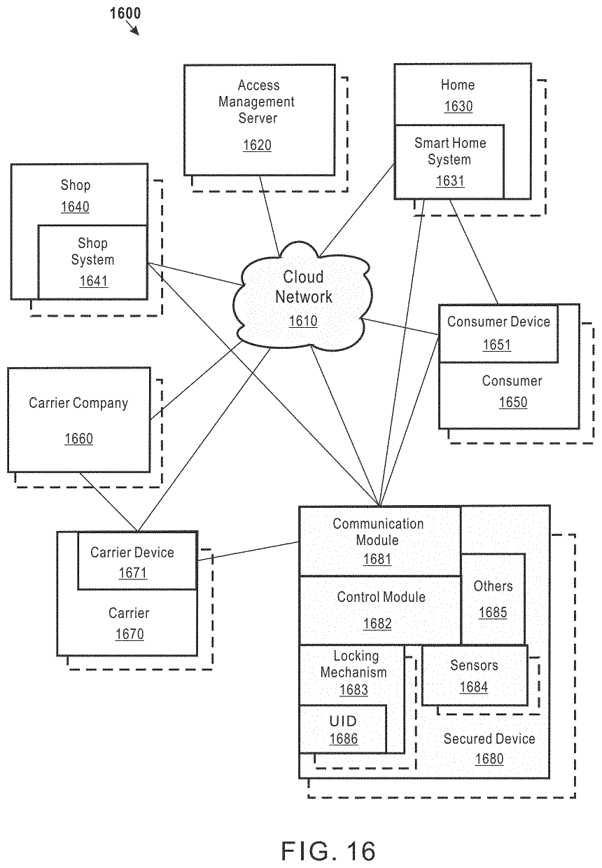

For example, at least one carrier (1670 in FIG. 16) access to at least one residential consumer's (1650 in FIG. 16) secured space (receptacle 970) to deliver and/or pick up at least one parcel 951. At least one secured space (receptacle 970) is controlled by a secured device 980 and 981 comprising at least one locking mechanism, with each of the locking mechanism having a unique identification (UID) assigned (such as QR code 881 in FIG. 8). The consumer (1650 in FIG. 16) installs a suitable access application (App) to a consumer device (1651 in FIG. 16), and registers the consumer device data and the locking mechanism UID 1686 (881 in FIG. 8 of QR code) to at least one access management server (1620 in FIG. 16) by the consumer device (1651 in FIG. 16) of the access App. The carrier (1670 in FIG. 16) installs a suitable access App to a carrier device (1671 in FIG. 16) and registers the carrier device data to at least one access management server (1620 in FIG. 16) by the carrier device (1671 in FIG. 16) of the access App. At least one access management server (1620 in FIG. 16) stores the consumer's (1650 in FIG. 16) and the carrier's (1670 in FIG. 16) registered data in at least one database. When the carrier (1670 in FIG. 16) arrives for delivery and/or pickup parcel, the carrier device (1671 in FIG. 16) obtains the locking mechanism UID 1686 (such as QR code 881 in FIG. 8) where the carrier intends to access the secured space (receptacle 970), and sending the locking mechanism UID (such as QR code 881 in FIG. 8) to at least one access management server (1620 in FIG. 16) by the carrier device (1671 in FIG. 16) of the access App. At least one access management server (1620 in FIG. 16) compares the data received from the carrier device (1671 in FIG. 16) of the locking mechanism UID 1686 (881 in FIG. 8 of QR code) with the registration data stored. At least one access management server (1620 in FIG. 16) sends an unlock code which matches to the locking mechanism UID 1686 (such as QR code 881 in FIG. 8) to the carrier device (1671 in FIG. 16) and/or to the secured device (1680 in FIG. 16). The locking mechanism is unlocked by the secured device 980 or 981 where the unlock code is received from the carrier device (1671 in FIG. 16) and/or from at least one access management server (1620 in FIG. 16). The carrier (1670 in FIG. 16) opens the secured space (receptacle 970) door 960 or 961 to deliver and/or to pick up the parcel 951, then closes the door 960 or 961 and locks down the locking mechanism by the carrier (1670 in FIG. 16). The access management server (1620 in FIG. 16) may receive the parcel data from the carrier company (1660 in FIG. 16), then compares the parcel data with stored data to retrieve the locking mechanism UID 1686 (such as QR code 881 in FIG. 8) and unlock code, then sending to the carrier device (1671 in FIG. 16) for late access to the secured space (receptacle 970). The consumer device (1651 in FIG. 16) may receive a notification from the access management server (1620 in FIG. 16) when the carrier (1670 in FIG. 16) arrives. The notification may include at least one of text, sound, video, parcel data, etc. The access management server (1620 in FIG. 16) may record any movement relating to the secured space access event. The notification or record may include event time, course of event, access person data (video, sound, carrier identity, etc.), theft attempts, etc.

FIG. 10 illustrates the purchase/parcel keeping devices 1010 or 1020 of different installations fixed on the wall 1070. The purchase/parcel keeping devices 1010 shown in compact mode with two doors 1060, 1061 secured device and/or locking mechanism 1080, 1082 and mail items receptacle 1063. The purchase/parcel-keeping device 1020 is shown in extended mode with opening door 1061 with back view of mail items receptacle 1063 and secured device and/or locking mechanism 1080. The wheels 1030 support and level the parcel-keeping device 1010 or 1020 and roll on the ground when the purchase/parcel-keeping device changes between compact mode and extended mode. The wheels 1030 may adjust to the level of the receptacle. In the angle of each side of the barrier, there is connecting string 1050 for secured interspace. There is camera 1090 in the wall which may communicate with the secured device 1080 and/or smart home device (not shown). The purchase/parcel-keeping device 1010 can be partially embedded into the wall 1070 by a built-in fixing device (not shown); or the purchase/parcel-keeping device 1020 is installed on the wall 1070 by attachment mode fixing device 1033.

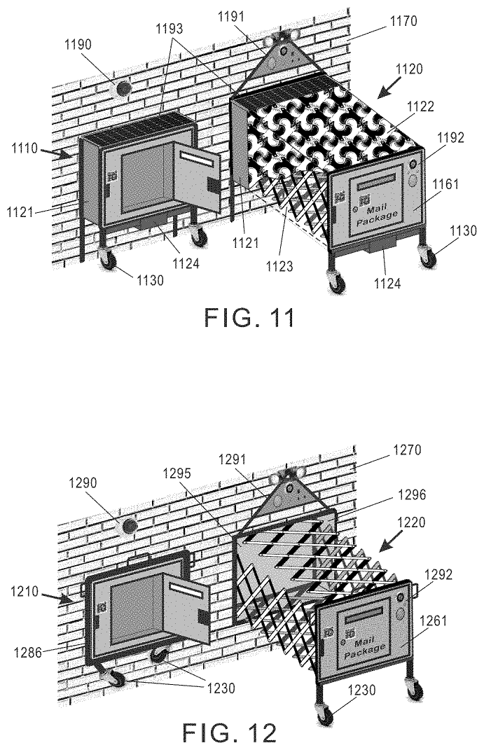

FIG. 11 illustrates the purchase/parcel keeping devices 1110 or 1120 of different outfits with wall 1170. The purchase/parcel-keeping device 1110 is shown in compact mode with solar cell 1193, side board 1121, and mixing device 1124. The mixing device 1124 contains a driver device for the wheels 1130, temperature control system for the receptacle, etc. The driver device may include battery, motor, drive system, etc. A camera 1190 is installed on the wall 1170. The purchase/parcel-keeping device 1120 shown on the door 1161 is properly equipped with equipment 1192 of camera, speaker, microphone, warning, alarm, sensor, etc. The equipment 1192 may be installed on a special plate 1191. The camera may be enabled to manage at least one of picture, video, barcode, QR code, items recognition, face recognition, biological recognition, dimensions recognition, motion recognition, depth perception, surveillance, etc. The equipment 1192 may be installed separately in a different location for predetermined purpose. A shield 1122 embraced outside of the receptacle 1123 may be formed using any suitable material (plastic cloth, waterproof fabric, insulation cloth, glass fabric, high-strength fabric, etc.). The material may be single or multilevel. The shield 1122 may have thermal insulation and/or constant temperature monitoring by a temperature sensor in the receptacle. The temperature may be controlled by the secured device, smart home system, etc. The shield 1122 may be inside of the receptacle 1123 of the purchase/parcel-keeping device 1120. The solar cell 1193 provides power for the mixing device 1124, secured device, etc. The power may come from the property's electricity. The mixing device 1124 may including battery, motor, drive system, etc. to move the wheels 1130 to change between compact mode and extended mode. The equipment 1192 and mixing device 1124 may communicate with and be controlled by the authorized device (smartphone, portable device, mobile device, smart home device, robot, unmanned vehicle, unmanned aerial vehicle (UAV), carrier device, consumer device, mobile device, Internet of Things (IoT) device, etc.), the smart home system and/or access management server over the communication network by wire and/or wireless. The purchase/parcel-keeping devices 1110, 1120 may be controlled by the authorized device to change between compact mode and extended mode, open and close door etc. of interactive activity, such as the door 1161 which may open or close by a robot's control, an unmanned vehicle, an UAV, etc. for auto deliver and/or to pick up the parcel.

FIG. 12 illustrates the purchase/parcel keeping devices 1210 or 1220 of different install by embed mode fixing device 1296 to embed into the wall 1270 from an opening 1295. The purchase/parcel keeping devices 1210 of the barrier are completely embedded in the wall 1270, only showing door frame 1286 out of the wall 1270 in the compacted mode. The wheels 1230 may contract or retract behind the door frame 1286. A camera 1290 is on the wall 1270. The purchase/parcel-keeping device 1220 is in the extended mode shown in opening 1295 on the wall 1270. The opening 1295 is for the barrier to fit in to the compacted mode. It change the embed mode fixing device 1296 to a through mode fixing device. The end of the purchase/parcel-keeping device 1220 may form another door inside wall 1270 of the property, so the purchase/parcel-keeping device 1220 may be embedded and/or cross the wall 1270. Consumer may collect the parcel inside the property. The purchase/parcel-keeping device 1220 is extended outside of the wall 1270 of property, but it may extend inside of the wall 1270 of the property instead. The purchase/parcel-keeping device 1220 has door 1261 with equipment 1292 such as camera, speaker, microphone, warning, alarm, sensor, etc. The equipment 1292 may be installed on a special plate 1291. The camera may be enabled to manage at least one of picture, video, barcode, QR code, items recognition, biological recognition, dimensions recognition, motion recognition, depth perception, surveillance, etc.

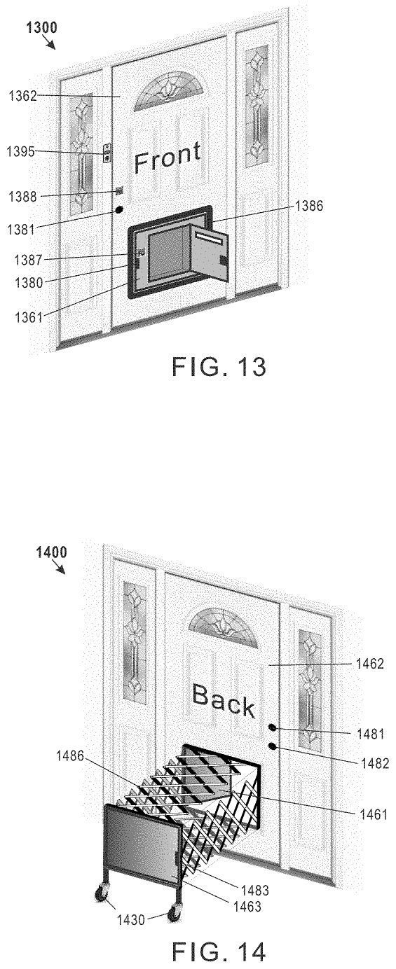

FIG. 13 illustrates the purchase/parcel-keeping device of different i install by through mode fixing device 1386 fixed in the door 1362 in part of front view of property 1300. The front view property 1300 is outside of the property 1300 with a property door 1362 embedding the purchase/parcel-keeping device in the compact mode. The purchase/parcel-keeping device has at least one door 1361, at least one secured device and/or locking mechanism 1380, at least one locking mechanism UID 1387. The property door 1362 also has secured device and/or locking mechanism 1381 and locking mechanism UID 1388. The property door 1362 may be locked/unlocked by at least one authorized device for the parcel delivery. On the doorframe is a doorbell 1395. The doorbell 1395 may include camera, speaker, microphone, sensor, etc. and may be installed on the door 1362 or the purchase/parcel keeping device. The doorbell 1395 may communicate with the authorized device, the smart home system and access management server over the communication network by wire and/or wireless. The purchase/parcel-keeping device may extend outside and/or inside of the door 1362 in the extended mode.

The property 1300 may be a purchase/parcel keeping storage, such as receptacle, box, bins, basket, container, room, garage, shed, cabinet, cage, etc. of a secured space. The door 1362 enables access into the secured space for keeping the purchase and/or parcel. The locking mechanism 1381 may comprise of a secured device. The locking mechanism UID 1388 is for identifying the locking mechanism 1381. The locking mechanism 1381 is for locking/unlocking the purchase/parcel keeping storage to secure the purchase and/or parcel. The door 1362 may be an individual door or a combination door which is with the purchase/parcel-keeping device etc.

FIG. 14 illustrates the purchase/parcel-keeping device 1486 fixed by the through mode fixing device on the door 1462 of back view of property 1400. The back view of property 1400 is inside the property with a property door 1462 where the purchase/parcel-keeping device 1486 traverses in the extended mode. The purchase/parcel-keeping device 1486 has outside door 1461, inside door 1463, at least one secured device and/or locking mechanism 1483. The property door 1462 also has at least one secured device and/or locking mechanism 1481, 1482. The outside door 1461 enables the carrier to deliver and/or pick up the parcel. The inside door 1463 prevents theft and enables the consumer to collect the parcel inside of property. The wheels 1430 for supporting purchase/parcel-keeping device 1486 and loading parcel. The wheels 1430 also help the property door 1462 open and close moving smoothly. The purchase/parcel-keeping device 1486 may include driver device, etc. aforesaid various device and/or equipment for predetermined purpose.

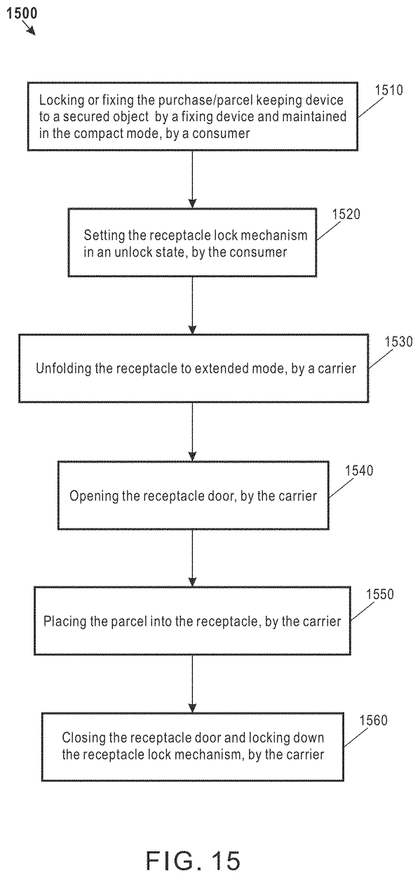

FIG. 15 illustrates an embodiment provided for residential consumer a purchase/parcel-keeping device method 1500 provided for residential consumers to receive at least one parcel, and secured in at least one receptacle by at least one locking mechanism. The receptacle is able to change from a compact mode to an extended mode to accommodate at least one parcel, otherwise the receptacle folds into compact mode to economize space. The method 1500 comprises:

locking or fixing the purchase/parcel-keeping device to a secured object (wall, fence, door, pillar, car, weight, ground, fixture, etc.) by a fixing device and maintained in the compact mode, by a consumer of step 1510;

setting the receptacle locking mechanism in an unlocked state, by the consumer of step 1520;

unfolding the receptacle to extended mode, by a carrier of step 1530;

opening the receptacle door, by the carrier of step 1540;

placing the parcel into the receptacle, by the carrier of step 1550;

closing the receptacle door and locking down the receptacle locking mechanism, by the carrier of step 1560.

FIG. 16 illustrates an embodiment of a secured access system 1600 provided for at least one carrier 1670 access to at least one residential consumer's 1650 secured space (receptacle, storage, basket, container, room, garage, etc.) to deliver and/or pick up at least one parcel (package, mail item, etc.) The access system 1600 comprises at least one access management server 1620 (backend, cloud instance, etc.) storing at least one consumer 1650 and at least one carrier 1670 of registration data and verifying the registration data where the access management server 1620 is received for a carrier device 1671; at least one secured device 1680 enables control to at least one locking mechanism 1683 of at least one of the secured space. Each of the locking mechanism 1683 has a unique identification (UID) 1686 assigned, and the locking mechanism UID 1686 identities which locking mechanism 1683 be locked/unlocked by a carrier device 1671, a consumer device 1651 and/or the access management server 1620 over a cloud network 1610 (cloud computing, communication network, IoT network, etc.); at least one of the consumer device 1651 enables the consumer 1650 to register the secured device 1680 comprising at least one of the locking mechanism UID 1686 to the access management server 1620 by a suitable access application (App) being installed on the consumer device 1651; at least one carrier device 1671 enabling the carrier 1670 to obtain the locking mechanism UID 1686 intending to access the secured space and sending the locking mechanism UID 1686 to the access management server 1620 by a suitable access App being installed on the carrier device 1670; wherein the access management server 1620 comprises the locking mechanism UID 1686 sent by the carrier device 1671 with the stored registration data. The comparison is matched, and the access management server 1620 sends an unlock code (mobile key, electronic key, etc.) to the carrier device 1671, then the carrier device 1671 sends the unlock code to the secured device 1680 to unlock the locking mechanism 1683 and/or the access management server 1620 sends an unlock code to the secured device 1680 to unlock the locking mechanism 1683 to access the secured space; wherein the access management server 1620 receives the parcel data from a carrier company 1660 (FedEx, UPS, DHL, USPS, Amazon, etc.), searching the parcel data within the stored registration data to find the secured device 1680 and the carrier device 1670 matched, sending at least one of the unlock code to the carrier company 1660 and/or the carrier device 1670 and storing the unlock code in the carrier device 1670 for later use; the carrier device 1671 obtains the locking mechanism UID 1686 intending to access the secured space, to retrieve the unlock code where stored in the carrier device 1671, send the unlock code to the secured device 1680 to unlock the locking mechanism 1683 by the access App to access the secured space. The consumer device 1651 and carrier device 1671 include at least one of authorized device, portable device, mobile device, smartphone, robot, unmanned aerial vehicle (UAV), IoT device, smart home device, etc. The lens on the device reads the UID physical image of the locking mechanism. The carrier device 1671 sends data to the access management server 1620, the data comprises at least one of: the locking mechanism UID, the GPS data, the carrier device UID, the secured device UID.

The secure access system 1600 includes plurality of parties including but not limited to home 1630, shop 1640, Carrier Company 1660, consumer 1650, carrier 1670, etc. Each party has its own account in the access management server 1620. The registration data may be stored in each owner account. The account is for the owner to manage and control their device and/or data, such as device data, registration data, locking mechanism UID 1686, recorded data, order data, tracking data, etc. The locking mechanism UID 1686 is associated with the consumer 1650 data stored and processed by the access management server 1620. The consumer 1650 data comprises secure device data, locking mechanism UID 1686, address, GPS location, etc. The access management server 1620 stores the locking mechanism's 1683 unlock code. The locking mechanism's 1683 unlock code may be a fixed code and/or a variable code. The locking mechanism's 1683 unlock code may be set by consumer 1650 or generated by the secured device 1680 and/or access management server 1620. Each locking mechanism may be unlocked by one or more unlock codes in the same period. The unlock code may be cryptographic for communication and/or all communication data are cryptographic. The access management server 1620 provides suitable access App for the consumer device 1651, carrier device 1671 and authorized device to download directly or download from third party (App store, Google Play, etc.). The access App used for communication with the access management server, secured device, shop system, smart home system, authorized device, etc.

The consumer 1650 home 1630 of smart home system 1631 is communicated to the cloud network 1610 by wire and/or wireless. The smart home system 1631 also enables communicating to consumer device, secured device 1680 and/or locking mechanism 1683. The secured device 1680 includes communication module 1681, control module 1682, locking mechanism 1683, sensors 1684 and others 1685 (processor module, etc.) The secured device 1680 may communicate with shop 1640 (virtual shop, physical shop, etc.) of shop system 1641 for consumer shopping matter. The secured device 1680 enables communication with at least one of access management server 1620, smart home system 1631, shop 1640 (virtual shop, physical shop, etc.), shop system 1641, consumer device 1651, carrier device 1671, smartphone, portable device, robot, unmanned aerial vehicle (UAV), authorized device, IoT device, etc. The secured device 1680 may have its own UID of secured device UID. The secured device UID may associate with at least one locking mechanism 1683 and/or locking mechanism UID 1686. The secured device 1680 may have smart and artificial intelligence (Al) ability. All servers, systems, devices, etc. enable communication with each other over the cloud network by wire and/or wireless.

The secure access system 1600 may have an access method for delivering a parcel to a secured space, a secured device 1680 to control the unlocking of at least one locking mechanism 1683, the locking mechanism 1683 is configured with a unique identification code (UID) 1686, the locking mechanism UID 1686 is displayed as physical image for authorized devices to read, comprises a carrier device 1671 to unlock the locking mechanism 1683. The method comprising:

obtaining the locking mechanism UID 1686 of the secured space by the lens of the carrier device 1671, then retrieving an unlocking code of the locking mechanism 1683 from the carrier device 1671, and transmitting the unlocking code to the secured device 1680, to unlock the locking mechanism 1683; or

obtaining the locking mechanism UID 1686 of the secured space by the lens of the carrier device 1671, sent to at least one access management server 1620 to retrieve the unlocking code of the locking mechanism 1683, and then the carrier device 1671 transmits the unlocking code to the secured device 1680, to unlock the locking mechanism 1683; or

obtaining the locking mechanism UID 1686 of the secured space by the lens of the carrier device 1671, sent to at least one access management server 1620 to retrieve the unlocking code of the locking mechanism 1683, and then directly transmitting the unlocking code to the secured device 1680, to unlock the locking mechanism 1683.

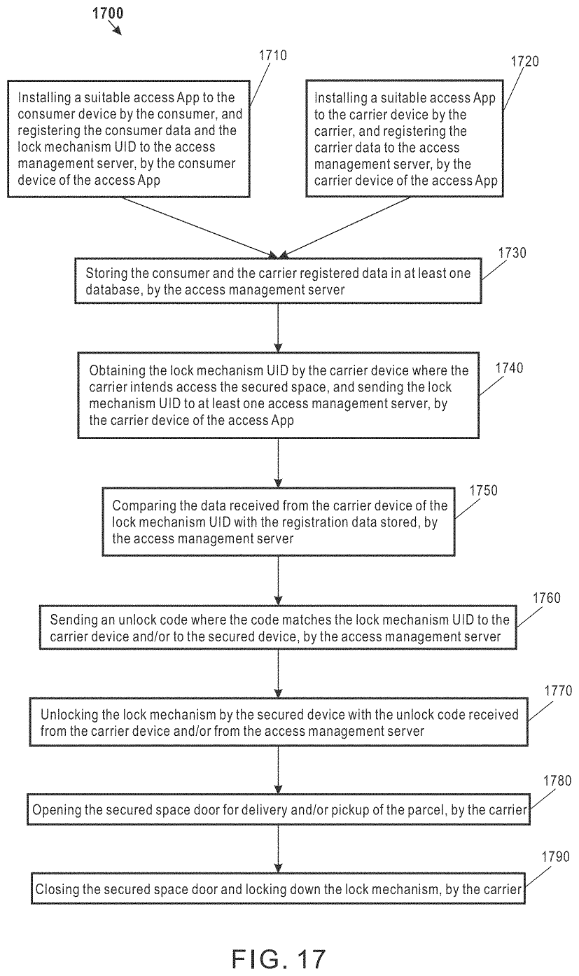

FIG. 17 illustrates an embodiment of a method 1700 providing at least one carrier access to at least one residential consumer secured space to deliver and/or pick up at least one parcel. At least one secured space is controlled by a secured device comprising at least one locking mechanism, with each of the locking mechanism having a unique identification (UID) assigned. The secured device enables communication with at least one access management server, at least one consumer device and at least one carrier device. The method 1700 comprises:

installing a suitable access application (App) to the consumer device by the consumer, and registering the consumer data (ownership, consumer device, phone number, address, secured device, locking mechanism, etc.) and the locking mechanism UID to the access management server, by the consumer device of the access App of step 1710;

installing a suitable access App to the carrier device by the carrier, and registering the carrier data (carrier, carrier device, etc.) to the access management server, by the carrier device of the access App of step 1720;

storing the consumer and the carrier registered data in at least one database, by the access management server of step 1730;

obtaining the locking mechanism UID by the carrier device where the carrier intends access the secured space, and sending the locking mechanism UID to the at least one access management server, by the carrier device of the access App of step 1740;

comparing the data received from the carrier device of the locking mechanism UID with the registration data stored, by the access management server of step 1750;

sending an unlock code where the code matches the locking mechanism UID to the carrier device and/or to the secured device, by the access management server of step 1760;

unlocking the locking mechanism by the secured device with the unlock code received from the carrier device and/or from the access management server of step 1770;

opening the secured space door for delivery and/or pickup of the parcel, by the carrier of step 1780;

closing the secured space door and locking down the locking mechanism, by the carrier of step 1790.

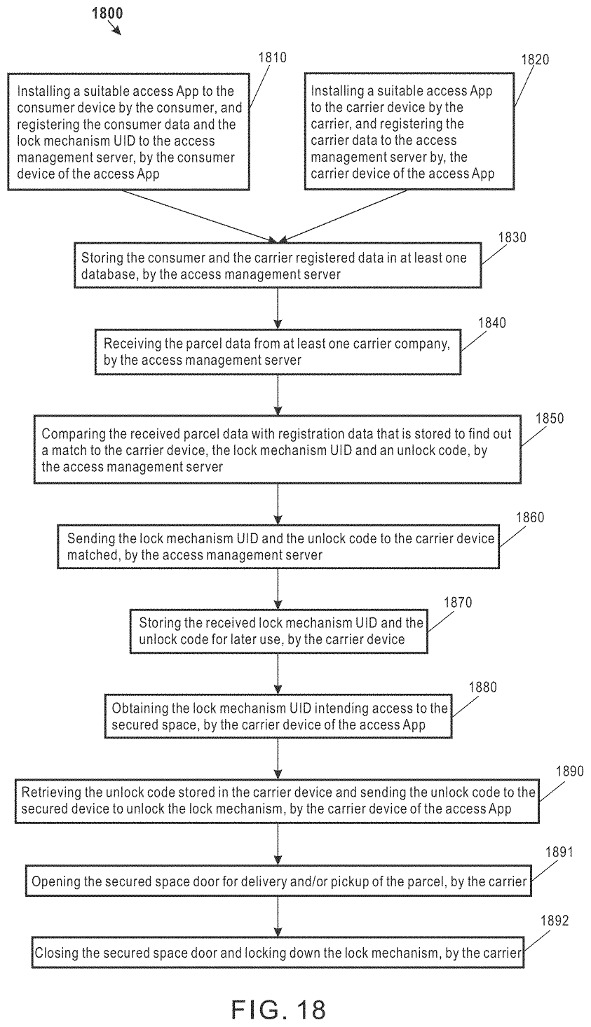

FIG. 18 illustrates an embodiment of a method 1800 providing at least one carrier access to at least one residential consumer secured space to delivery and/or pickup at least one parcel. At least one secured space is controlled by a secured device comprising at least one locking mechanism, with each locking mechanism having a unique identification (UID) assigned. The secured device enables communication with at least one access management server, at least one consumer device and at least one carrier device. The method 1800 comprises:

installing a suitable access application (App) to the consumer device by the consumer, and registering the consumer data (ownership, consumer device, phone number, address, secured device, locking mechanism, etc.) and the locking mechanism UID to the access management server, by the consumer device of the access App of step 1810;

installing a suitable access App to the carrier device by the carrier, and registering the carrier data (carrier, carrier device, etc.) to the access management server, by the carrier device of the access App of step 1820;

storing the consumer and the carrier registered data in at least one database, by the access management server of step 1830;

receiving the parcel data (name, address, tracking number, phone number, etc.) from at least one carrier company (FedEx, UPS, USPS, Amazon, etc.), by the access management server of step 1840;

comparing the received parcel data with registration data that is stored to find out a match to the carrier device, the locking mechanism UID and an unlock code, by the access management server of step 1850;

sending the locking mechanism UID and the unlock code to the carrier device matched, by the access management server of step 1860;

storing the received locking mechanism UID and the unlock code for later use, by the carrier device of step 1870;

obtaining the locking mechanism UID intending access to the secured space, by the carrier device of the access App of step 1880;

retrieving the unlock code stored in the carrier device and sending the unlock code to the secured device to unlock the locking mechanism, by the carrier device of the access App of step 1890;

opening the secured space door for delivery and/or pickup of the parcel, by the carrier of step 1891;

closing the secured space door and locking down the locking mechanism, by the carrier of step 1892.

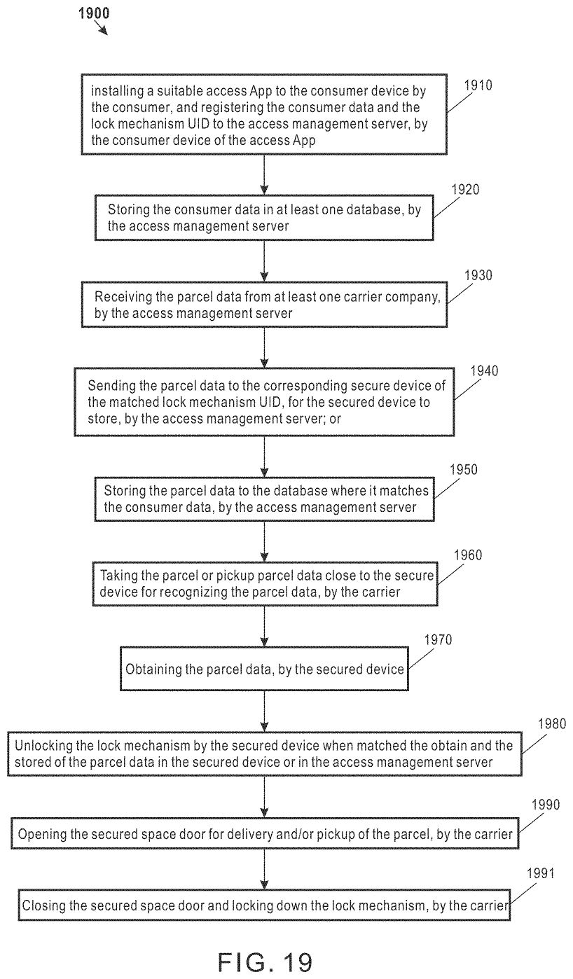

FIG. 19 illustrates an embodiment of a method 1900 providing at least one carrier access to at least one residential consumer secured space to deliver and/or pickup at least one parcel. At least one secured space is controlled by a secured device comprising at least one locking mechanism, with each locking mechanism having a unique identification (UID) assigned. The secured device enables communication with at least one access management server, at least one consumer device to enable processing parcel data. The method 1900 comprises:

installing a suitable access application (App) to the consumer device by the consumer, and registering the consumer data (secured device, address, secured space, GPS location, ownership, etc.) and the locking mechanism UID to the access management server, by the consumer device of the access App of step 1910;

storing the consumer data in at least one database, by the access management server of step 1920;

receiving the parcel data (name, address, tracking number, phone number, etc.) from at least one carrier company, by the access management server of step 1930;

sending the parcel data to the corresponding secured device of the matched locking mechanism UID, for the secured device to store, by the access management server of step 1940; or

storing the parcel data to the database where it matches the consumer data, by the access management server of step 1950;

taking the parcel or pickup parcel data close to the secured device for recognizing the parcel data, by the carrier of step 1960;

obtaining the parcel data, by the secured device of step 1970;

unlocking the locking mechanism by the secured device when matched the obtain and the stored of the parcel data in the secured device or in the access management server of step 1980;

opening the secured space door for delivery and/or pickup of the parcel, by the carrier of step 1990;

closing the secured space door and locking down the locking mechanism, by the carrier of step 1991.

Thus, while there have been shown and described and pointed out fundamental novel features of the inventive device, system and method as applied to preferred embodiments thereof, it will be understood that various omissions and substitutions and changes in the form and details of the products and methods illustrated, and in their operation, can be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A folding cart for residential consumers to use, comprising of wheels, receptacle and cover/door of the receptacle, characterized in that at least one locking mechanism is installed on least one of the receptacle and/or at least one of the cover/door, said locking mechanism can be opened only by an authorized person/device, so the receptacle becomes a secured space.

2. The cart of claim 1, characterized in that the cart further comprises at least one fixing device for setting the trolley outside the house to receive and keep at least one parcel delivered by at least one carrier.

3. The cart of claim 2, characterized in that the fixing device is at least one of the following mode fixing device: lock mode fixing device, attachment mode fixing device, embed mode fixing device, through mode fixing device or implant mode fixing device.

4. The cart of claim 1, characterized in that the cart is at least one of: shopping cart/trolley, personal cart/trolley, family cart/trolley, purchase/parcel-keeping cart/device or parcel-keeping device.

5. The cart of claim 1, characterized in that the locking mechanism is modified and/or combined with at least one of following: padlock, combination lock, chain lock, cable lock, latch lock, bolt lock, hook lock, electronic lock, fingerprint lock or smart lock.

6. The cart of claim 1, characterized in that the locking mechanism comprises at least one of shackle, latch, bolt, hook, cable, chain or rope which is at least 0.3 inches long.

7. The cart of claim 1, characterized in that the locking mechanism comprises a sleeve that is sleeved on a portion of the receptacle frame or the door frame, to enable rotation of the locking mechanism.

8. The cart of claim 1, the door is at least one of: cover, lid, sliding door, accordion door, folding door or rolling door.

9. The cart of claim 1, characterized in that the cart further comprises at least one secured device to control the at least one locking mechanism, the secured device enabling communication with at least one access management server and/or at least one authorized device.

10. The cart of claim 1, characterized in that the locking mechanism further comprises a unique identification (UID), the locking mechanism UID enable obtain by at least one of way: barcode, QR code, RFID or NFC.

11. The cart of claim 1, characterized in that the cart further comprises at least one of:
secured space, shield, unique identification (UID), barcode, QR code, RFID, NFC, mechanical lock, padlock, combination lock, chain lock, cable lock, latch lock, bolt lock, hook lock, electronic lock, fingerprint lock, smart lock, communication module, processing module, control module, camera, speaker, microphone, alarm, fingerprint, GPS, sensor, battery, solar cell, thermal insulation, constant temperature, ventilation, artificial intelligence (Al), smart home device or motor, fixing device, mounting parts, assemblies, fixture components and position for the fixing device.

12. An access method for delivering a parcel to a secured space, characterized in that a secured device to control the unlock of at least one locking mechanism, the locking mechanism is configured with a unique identification code (UID), the locking mechanism UID is displayed as physical image for authorized devices to read, comprises a carrier device to unlock the locking mechanism, The method comprising:
obtaining the locking mechanism UID of the secured space by the lens of the carrier device, then retrieving an unlocking code of the locking mechanism from the carrier device, and transmitting the unlocking code to the secured device, to unlock the locking mechanism; or
obtaining the locking mechanism UID of the secured space by the lens of the carrier device, sent to at least one access management server to retrieve the unlocking code of the locking mechanism, and then the carrier device transmits the unlocking code to the secured device, to unlock the locking mechanism; or
obtaining the locking mechanism UID of the secured space by the lens of the carrier device, sent to at least one access management server to retrieve the unlocking code of the locking mechanism, and then directly transmitting the unlocking code to the secured device, to unlock the locking mechanism.

13. The method of claim 12, characterized in that the secured space is at least one of:
receptacle, storage, box, bin, basket, container, room, garage, shed, cabinet and cage;
or it locate in at least one of: shopping cart, shopping trolley, personal cart/trolley, foldable cart/trolley, family cart/trolley, purchase/parcel keeping cart/device and parcel-keeping device.

14. The method of claim 12, characterized in that the secured space further comprises at least one of: barcode, QR code, RFID, NFC, mechanical lock, padlock, combination lock, chain lock, cable lock, electronic lock, fingerprint lock, smart lock, communication module, processing module, control module, camera, speaker, microphone, alarm, fingerprint, GPS, sensor, battery, solar cell, secured device, thermal insulation, constant temperature, ventilation, artificial intelligence (Al), smart home device, wheels and motor.

15. The method of claim 12, characterized in that the authorized device is at least one of: smartphone, portable device, mobile device, robot, unmanned aerial vehicle (UAV), smart home device, consumer device or Internet of Things (IoT) device.

16. The method of claim 12, characterized in that the locking mechanism UID enabled is obtained by at least one of way: barcode, QR code, RFID or NFC.

17. The method of claim 12, characterized in that the door is at least one of: cover, lid, sliding door, accordion door, folding door or rolling door.

18. The method of claim 12, characterized in that the secured device further communicates with at least one of: authorized device, smartphone, portable device, mobile device, robot, unmanned aerial vehicle (UAV), smart home device or Internet of Things (IoT) device.

19. A access method for delivering a parcel to a secured space, characterized in that a secured device to control the unlock of at least one locking mechanism, the locking mechanism is configured with a unique identification code (UID), the secured device is communicating with at least one access management server, the method comprising:
receiving the parcel data from at least one carrier company by the access management server;
sending the parcel data to the corresponding secured device of the matched locking mechanism UID for the secured device to store, by the access management server; or
storing the parcel data to the database where it matches the locking mechanism UID, by the access management server;
taking the parcel or pick up parcel data close to a lens and/or sensor of the secured device for recognizing the parcel data, by the carrier;
obtaining the parcel data by the secured device, the parcel data is the unlock code when it matches with the stored the parcel data in the secured device and/or the access management server of the parcel data;
unlocking the locking mechanism which is controlled by the secured device.

20. The method of claim 19, characterized in that the secured space is at least one of: receptacle, storage, box, bin, basket, container, room, garage, shed, cabinet and cage; or it locate in at least one of: shopping cart, shopping trolley, personal cart/trolley, foldable cart/trolley, family cart/trolley, purchase/parcel keeping cart/device and parcel-keeping device.
